(19) United States
(12) Patent Application Publication
(10) Pub. No.: US 2013/0179811 A1
(43) Pub. Date: Jul. 11, 2013

(54) PROJECTION DYNAMIC ICON KNOBS

(71) Applicants: Wes Nagara, Commerce Township, MI (US); T. C. Wingrove, Canton, MI (US); Michael Tschirhart, Ann Arbor, MI (US)

(72) Inventors: Wes Nagara, Commerce Township, MI (US); T. C. Wingrove, Canton, MI (US); Michael Tschirhart, Ann Arbor, MI (US)

(73) Assignee: VISTEON GLOBAL TECHNOLOGIES, INC., Van Buren Twp., MI (US)

(21) Appl. No.: 13/344,260

(22) Filed: Jan. 5, 2012

(51) Int. Cl. G06F 3/048

(52) U.S. Cl. 715/765

(57) ABSTRACT

An interface system includes a control, a projector, and a controller. The control has a substantially transparent main body. The projector is configured to project a plurality of control markings on the transparent main body. The controller is in communication with the projector. The controller is configured to cause the projector to project one of the plurality of control markings onto the main body, dependent upon a selection of a subsystem to be managed by the interface system.

### FIELD OF THE INVENTION

The present disclosure relates to a human-to-machine interface system and more particularly to a human-to-machine interface system for controlling vehicle subsystems.

### BACKGROUND OF THE INVENTION

Modern human-to-machine interface (HMI) systems for controlling vehicle subsystems such as climate control systems and media systems have included physical controls such as knobs or buttons. The knobs and buttons are typically etched or provided with other types of labels and icons to identify the function of that specific control. The knobs and buttons are manufactured from various types of plastic and metal, and be provided in a variety of colors.

Once etched, labeled, painted, decorated, or otherwise marked, the knobs and buttons of the HMI are physically and permanently altered, and can no longer be changed to have a different icon or label. Likewise, the labels placed on the knobs and buttons can have only one icon and cannot be changed. The physical markings and labels also wear out during use. Furthermore, the knobs and buttons can be off-color from a customer approved master sample due to manufacturing variation, which can result in undesirable quality control consequences.

A primary disadvantage of etched knobs and buttons is an inability to change the icons and other markings based on a menu or a current active subsystem of the vehicle. The etched icons also cannot be dynamically altered when activating a function within the subsystem such as when adjusting fan speed of a climate control system or modifying volume of a media system, for example.

There is a continuing need for an optimized and simplified interface system having controls that dynamically change appearance including labeling and icons. Desirably, the labeling and icons will change depending on which subsystem is active, and may also be based on a function within the subsystem.

### SUMMARY OF THE INVENTION

In concordance with the instant disclosure, an optimized and simplified interface system having controls that dynamically change appearance including labeling and icons, which change depending on which subsystem is active, and which may also be based on a function within the subsystem, is surprisingly discovered.

In an exemplary embodiment, a control of an interface system is optimized and simplified by providing the control as transparent, for example, a clear plastic knob or button, and dynamically changing the labeling and the icons of the control. This is achieved by projecting an image onto the transparent control. The image will change depending on which current subsystem is active. For example, if a media system such as a radio is the active subsystem, then a volume-based image will be projected onto the control. If the active subsystem is a climate control system, then a fan speed image can be projected onto the control. The control also dynamically changes to visually demonstrate feature adjustments of the active subsystem. For example, where the active system is the media system, an arc projected onto the control may increase dynamically as the volume increases. The icon, font, color, size and many other attributes can also be dynamically updated.

Illustratively, the interface system includes a processor, a projector, a camera, and clear buttons or knobs that interact to produce a simplified human-to-machine interface. Graphics are displayed by projection onto the clear buttons and knobs, and can change dynamically. The interface system of the present disclosure addresses complications of known interface systems by dynamically changing the icons on clear controls such as knobs and buttons. The icons change to adapt based on the current active system. Updates within the current system can also be updated.

In one embodiment, an interface system includes a control having a substantially transparent main body, a projector configured to project a plurality of control markings onto the transparent main body of the control, and a controller in communication with the projector. The controller is configured to cause the projector to project one of the plurality of control markings onto the transparent main body of the control. The one of the plurality of control markings is dependent upon a selection of a subsystem to be managed by the interface system.

In another embodiment, the interface system further includes a camera in communication with the controller. The camera is configured to detect an actuation of the control by a user and communicate the actuation to the controller.

In a further embodiment, the interface system also includes at least one substantially transparent screen disposed adjacent the control. The projector is configured to project the plurality of control markings onto both the substantially transparent main body of the control and the at least one substantially transparent screen. At least one of the one of the plurality of control markings and the another one of the plurality of control markings is dynamically altered in response to a change in the selected subsystem caused by the actuation of the control by the user.

### DRAWINGS

The above, as well as other advantages of the present disclosure, will become readily apparent to those skilled in the art from the following detailed description, particularly when considered in the light of the drawings described herein.

FIG. 1 is a schematic illustration of an interface system according to one embodiment of the present disclosure, wherein a control of the interface system includes a transparent knob onto which at least one control marking is projected;

FIG. 2 is a schematic illustration of the interface system depicted in FIG. 1, wherein the control of the interface system includes the transparent button onto which the at least one control marking is projected;

FIG. 3 is a schematic illustration of an interface system according to another embodiment of the present disclosure, wherein a camera is employed to monitor an actuation of a control of the interface system, and the control includes a transparent knob onto which at least one control marking is projected;

FIG. 4 is a schematic illustration of the interface system depicted in FIG. 3, wherein the control of the interface system includes the transparent button onto which the at least one control marking is projected;

FIG. 5 is a schematic illustration of an interface system according to a further embodiment of the present disclosure, wherein a control of the interface system includes at least one control marking projected onto a transparent screen that is monitored by a camera;

FIG. 6 is a schematic illustration of the interface system depicted in FIG. 5, wherein the control of the interface system includes the transparent button onto which the at least one control marking is projected;

FIG. 7 is a schematic illustration of an interface system according to another embodiment of the present disclosure, wherein a camera is employed to monitor an actuation of a control of the interface system, and the control includes a transparent knob onto which at least one control marking is projected from a mirror at which a projector is aimed;

FIG. 8 is a schematic illustration of the interface system depicted in FIG. 7, wherein the control of the interface system includes the transparent button onto which the at least one control marking is projected from the mirror;

FIG. 9 is a front elevational view of the interface system according to FIGS. 1-8, wherein the interface system manages a climate control subsystem; and

FIG. 10 is a front elevational view of the interface system according to FIGS. 1-8, wherein the interface system manages a media subsystem.

### DETAILED DESCRIPTION OF THE INVENTION

The following detailed description and appended drawings describe and illustrate various embodiments of the invention. The description and drawings serve to enable one skilled in the art to make and use the invention, and are not intended to limit the scope of the invention in any manner. In respect of the methods disclosed, the steps presented are exemplary in nature, and thus, are not necessary or critical.

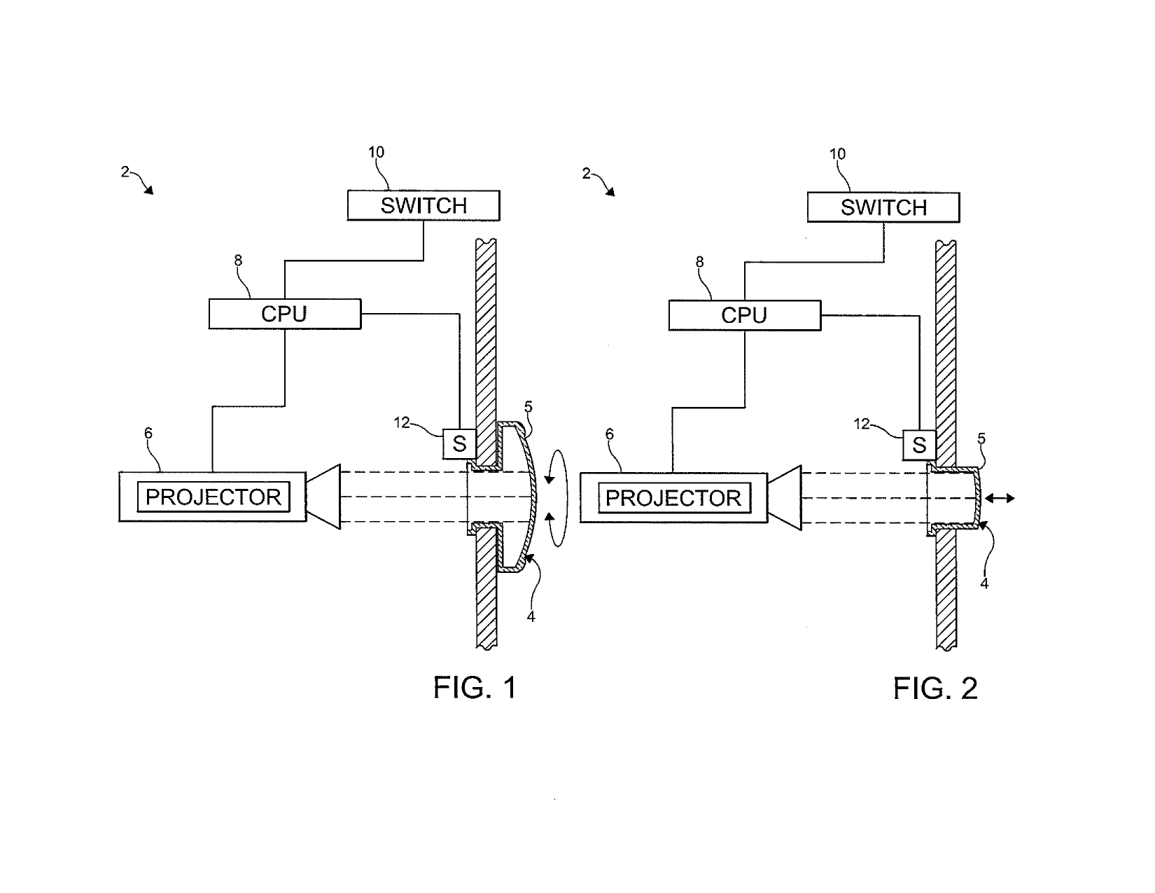

With reference to FIGS. 1-2, an interface system 2 according to one embodiment of the disclosure is shown. The interface system 2 includes a control 4 that permits a user to manually manage a subsystem (not shown). As nonlimiting examples, the subsystem may be one of a climate control system and a media system for a vehicle. Other subsystems may also be manually managed with the control 4, as desired.

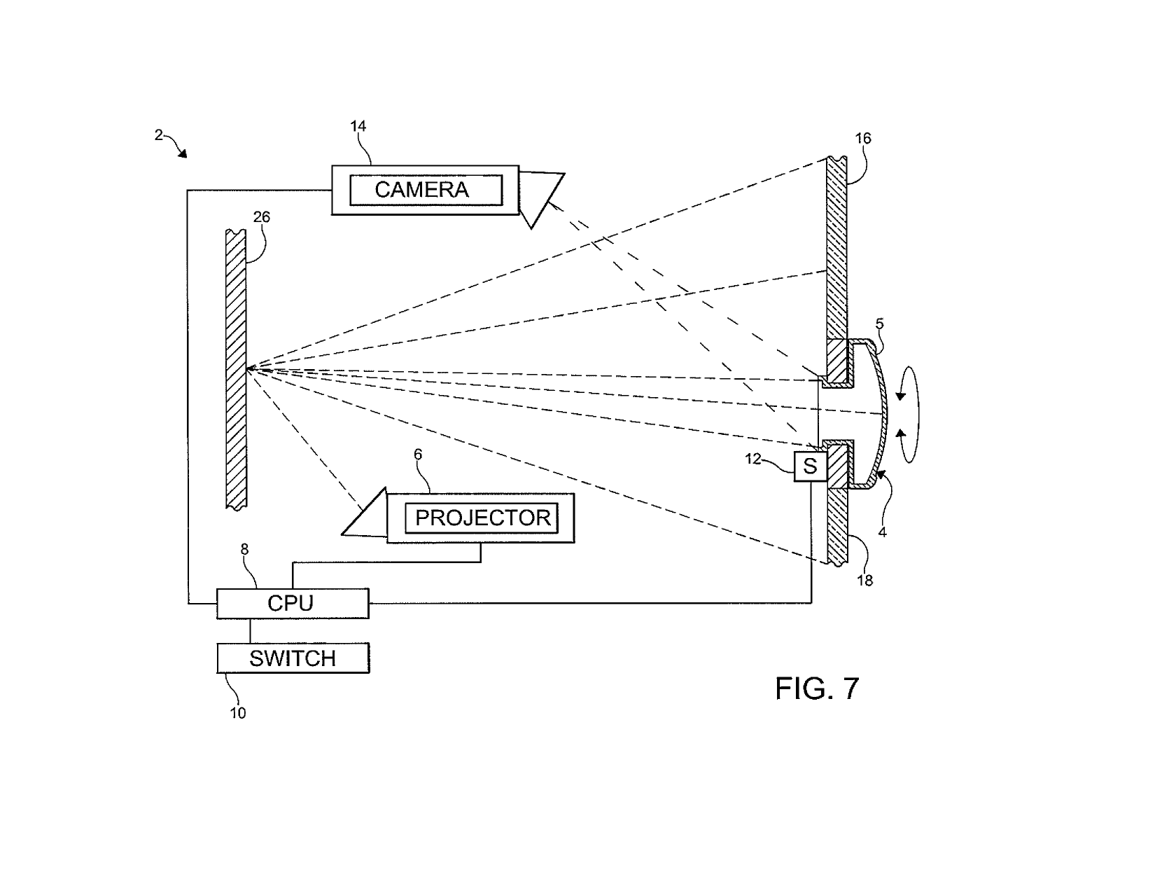

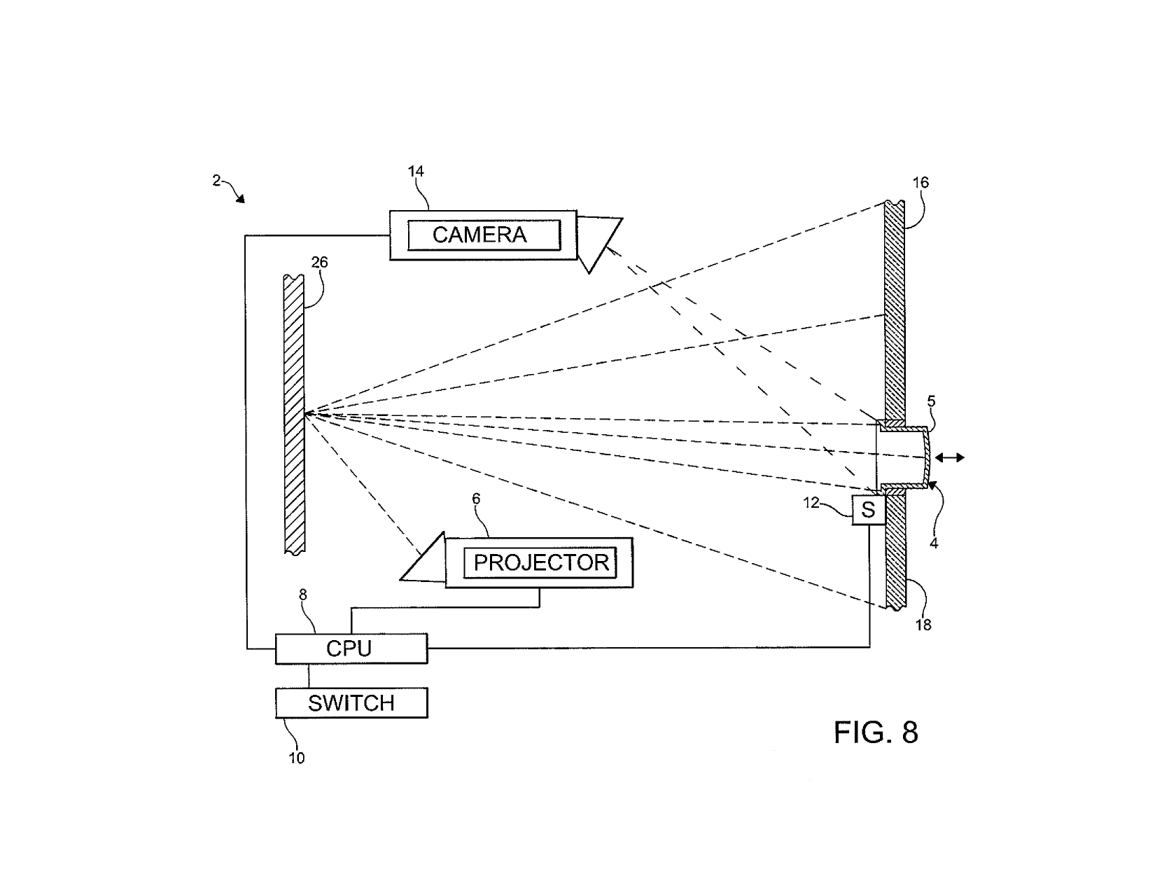

The control 4 of the interface system 2 has a transparent main body 5. A projector 6 is configured to project a plurality of control markings 20 (shown in FIGS. 7 and 8) onto a substantially transparent main body 5 of the control 4. The substantially transparent main body 5 may be entirely transparent, translucent, or may be formed from a material that permits light to pass through in only one direction, as desired.

In certain embodiments, the projector 6 is a pico projector. In other embodiments, the projector 6 includes a laser projection system. Alternative types of projection suitable for projecting the plurality of control markings 20 onto the transparent main body 5 of the control 4 may also be used within the scope of the present disclosure.

The control 4 may be manually actuatable from at least a first position to a second position. As nonlimiting examples, the control 4 is one of a rotatable knob (shown in FIG. 1) and a push button (shown in FIG. 2). The rotatable knob and the control 4 may be freely moved or biased, for example, with a biasing spring. The control 4 may be embedded in a console of a vehicle, for example, for manual actuation by the user of the vehicle when managing the subsystem of the vehicle. A skilled artisan may dispose the control 4 at other locations that permit the manual actuation by the user, as desired.

In other embodiments, the control 4 is identified by a projection onto an integral surface, and not movable from a first position to a second position. The control 4 may instead be actuated by a sensed touching of the projection by the user. Alternatively, the control 4 may be actuated by a sensed approaching of a finger of the user. In other examples, the control 4 may be a pressure sensitive location on a surface, and the detection of pressure caused by the finger of the user may be treated as the manual actuation of the control 4. Other types of controls 4 are also within the scope of the present disclosure.

A controller 8 is in communication with the projector 6. The controller 8 is configured to cause the projector 6 to project one of the plurality of control markings 20 onto the transparent main body 5 of the control 4. In particular, the one of the plurality of control markings 20 is dependent upon a selection of the subsystem to be managed by the interface system 2. It should therefore be understood that the one of the plurality of control markings 20 will be changed or altered by the controller 8 where the user makes a selection of a different subsystem from an original subsystem.

The interface system 2 further includes a switch 10 that permits the user to select different subsystems to be managed with the control 4. The switch 10 is in communication with the controller 8. The switch 10 may be a physical switch or a virtual switch, as desired. In one example, the switch 10 may be formed by other knobs or buttons formed in the console. In another example, the switch 10 may be a virtual switch (shown in FIGS. 7 and 8) formed via projection by the projector 6. Other means for providing the switch 10 for permitting the selection of different subsystems by the user may be employed, as desired.

As shown in FIGS. 1 and 2, the interface system 2 may further include at least one sensor 12. The sensor 12 is in communication with the controller 8. In particular, the sensor 12 is configured to detect an actuation of the control 4 by the user of the interface system 2. As a nonlimiting example, the sensor 12 may be an electromechanical device disposed adjacent the control 4 for detecting at least one of an amount of actuation and a rate of actuation of the control 4 by the user. Other sensor types and locations for the sensor 12 within the interface system 2 may also be used within the scope of the present disclosure.

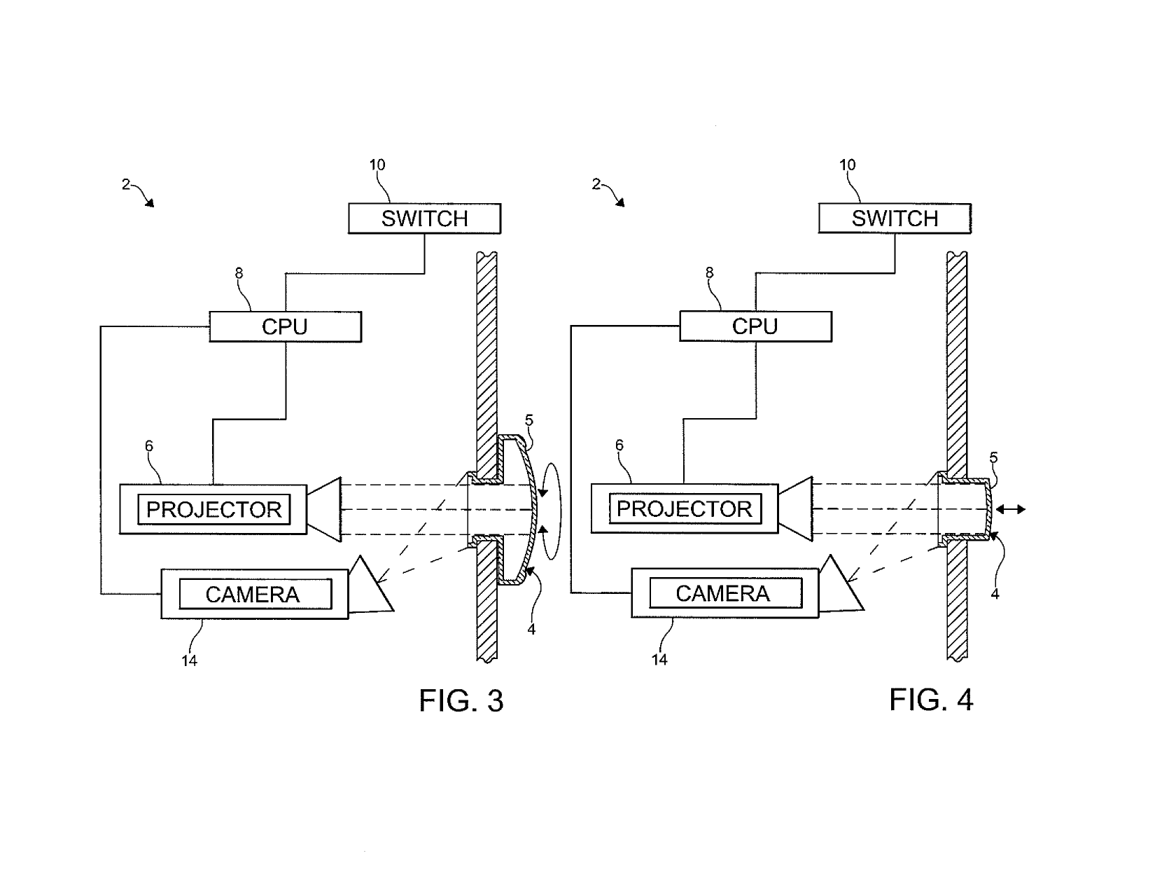

Referring now to FIGS. 3 and 4, the interface system 2 may include a camera 14. The camera 14 is in communication with the controller 8, and is configured to detect an actuation of the control 4 by the user. The camera 14 may also be configured to detect at least one of an amount of actuation and a rate of actuation of the control 4 by the user. As such, the camera 14 may be provided as a replacement for the sensor 12, or may be provided in addition to the sensor 12. Where the camera 14 is employed as the sensor 12, it should be appreciated that no electrical circuits or mechanical connections are required between the control 4 and the controller 8. The knobs and buttons can contain electrical circuits or mechanical connections, if desired.

Additionally, the camera 14 may be calibrated in order to detect and track a finger of the user as the finger approaches the control 4. The approach of the finger may be treated as the actuation of the control 4 by the controller 8 of the interface system 2. As a nonlimiting example, the camera 14 may identify the control 4 as having been actuated when the finger of the user comes within a predetermined distance of the control 4. In a particular example, the camera 14 may identify the control as having been actuated when the finger comes within about 2 mm from the control 4. Other movements of the finger of the user relative to the control 4 may also be tracked by the camera 14, and treated as the manual actuation of the control 4 by the user, as desired.

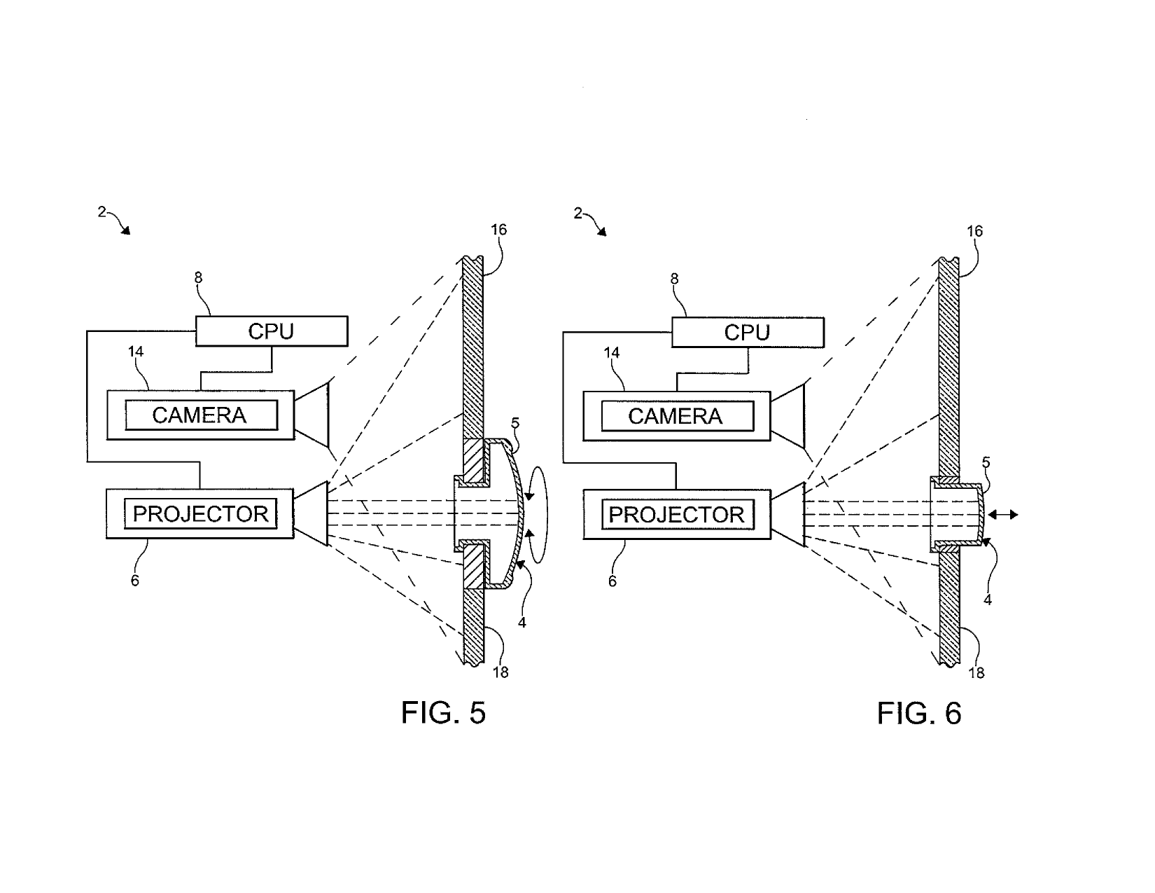

Referring now to FIGS. 5 and 6, the interface system 2 may further include at least one substantially transparent screen 16, 18. The substantially transparent main screen 16, 18 may be entirely transparent, translucent, or may be formed from a material that permits light to pass through in only one direction, as desired.

The at least one transparent screen 16, 18 may be disposed adjacent the control 4, for example. In a particular embodiment, the at least one transparent screen 16, 18 includes a first substantially transparent screen 16 disposed above the control 4, and a second substantially transparent screen 18 disposed below the control 4. Other substantially transparent screens 16, 18 may also be employed. In addition to projecting the plurality of control markings 20 onto the transparent main body 5 of the control 4, the projector 6 may also be configured to project the plurality of control markings 20 onto the at least one transparent screen 22, 24.

Where the at least one transparent screen 16, 18 is employed, the camera 14 in communication with the controller 8 may be configured to detect an interaction of the user with the at least one transparent screen 16, 18. In particular embodiments, the at least one transparent screen 16, 18 may be employed by the user for the selection of the subsystem to be managed by the interface system 2. As such, the at least one transparent screen 16, 18 may be used in addition to, or as a substitute for, the switch 10 in permitting the user to select different subsystems for management.

With reference to FIGS. 7 and 8, the interface system 2 may further include at least one optic 26 such as a mirror, lens, fiber optic, or other reflective means at which the projector 6 is aimed. The at least one optic 26 is configured to reflect the projection of the control markings 20 from the projector 6 onto at least one of the control 4 and the at least one transparent screen 16, 18. For example, the at least one optic 26 may be disposed behind the substantially transparent control 4. Although a single optic 26 is shown in FIGS. 7 and 8, one of ordinary skill in the art should appreciate that any number of optics 6 may be employed within the scope of the present disclosure.

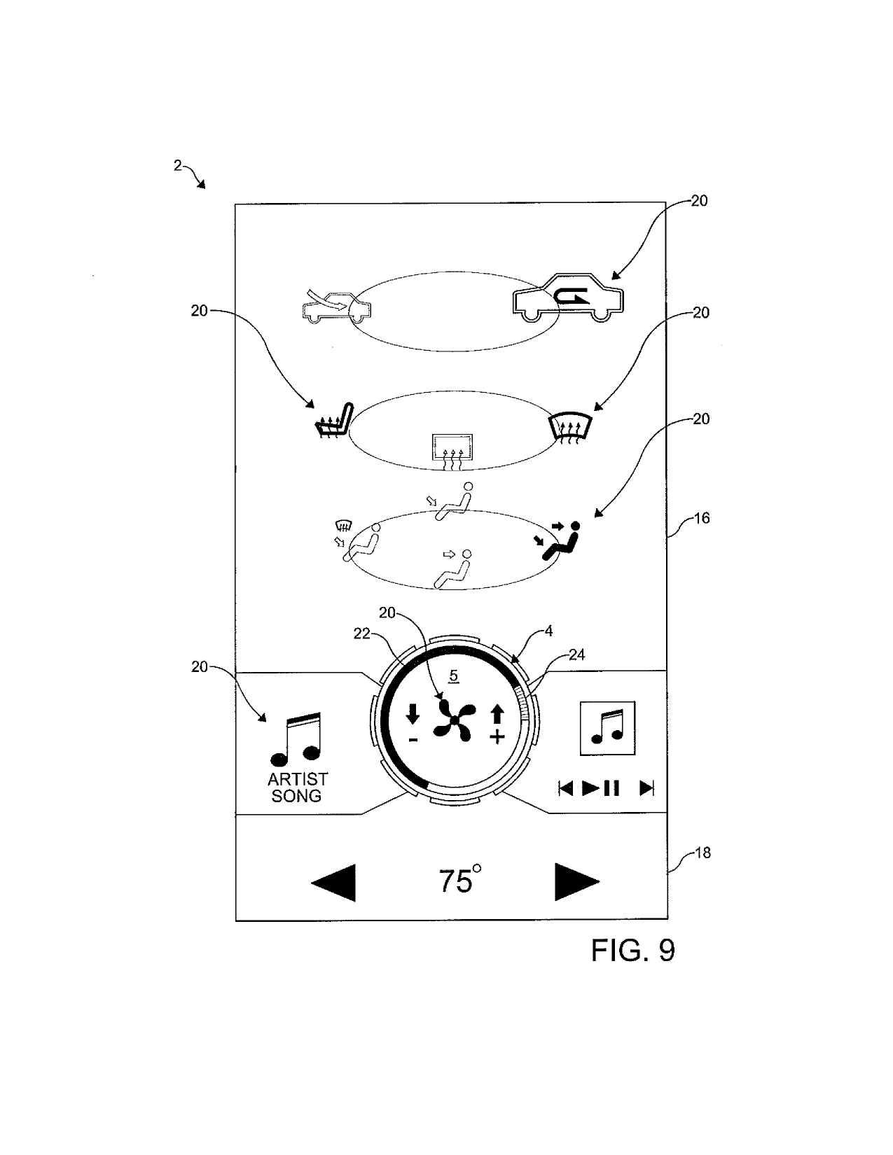

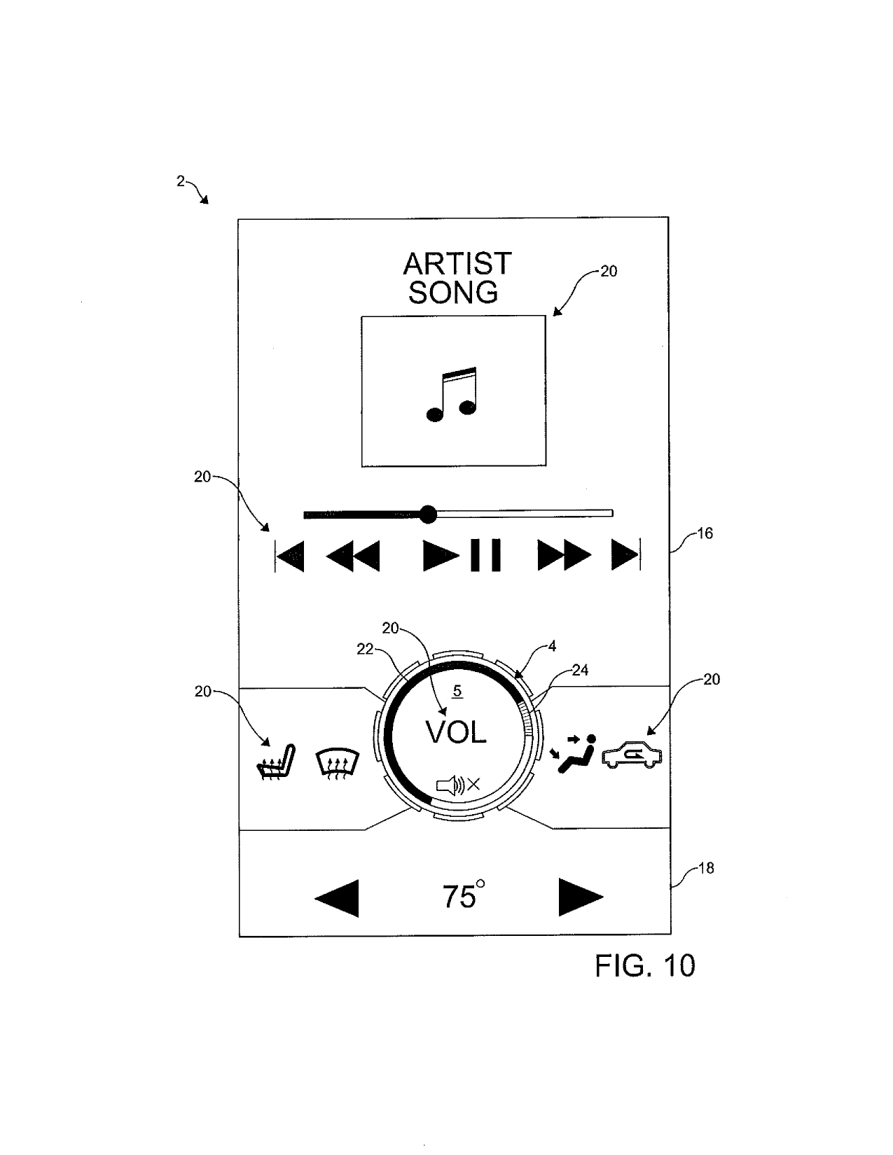

As shown in FIGS. 9 and 10, the one of the plurality of control markings 20 projected onto the control 4 and the at least one transparent screen 16, 18 may include at least one of an icon, a label, and a graphical representative of the selected subsystem. Advantageously, the one of the plurality of control markings 20 projected by the projector 6 may be dependent upon a selection of the subsystem to be managed by the interface system 2. Thus, where the user selects a different subsystem, the one of the plurality of control markings 20 may be altered to another one of the plurality of control markings 20 that is indicative of the selected subsystem.

The icons, labels, and graphics may also be representative of a function within the selected subsystem. Furthermore, the one of the plurality of control markings 20 may be dynamically altered in response to a change in the function of the selected subsystem. The control markings 20 thereby provide a dynamic, real-time indication to the user of the functioning of the subsystem selected for management.

For example, the one of the plurality of control markings 20 may also include at least one indicator that provides the dynamic, real time indication to the user of the functioning of the subsystem. In certain examples, at least one of a font, a color, and a size of the one of the plurality of control markings 20 may be altered in response to the change in the selected subsystem. In a particular example, the indicator is at least one arc 22, 24 disposed adjacent a side surface of the control 4. The at least one arc 22, 24 may include a first arc 22 and a second arc 24, which may overlap or be disposed adjacent one another, and which show a difference between a manual setting by the user and the real-time functioning of the subsystem. At least one of a length and a color of the at least one arc 22, 24 may be altered in response to the change in the selected subsystem.

Where the selected subsystem is a climate control system, as shown in FIG. 7, the first arc 22 may be an indicator of actual cabin temperature, and the second arc 24 may be an indicator of the cabin temperature setting that is manually selected by the user. Where the selected subsystem is a media system, as shown in FIG. 10, the first arc 22 may be an indicator of actual volume and the second arc 24 may be an indicator of a maximum volume setting that is manually selected by the user. One of ordinary skill in the art may select other subsystems, having different functions that may be manually selected and managed by the user, as desired.

Advantageously, the interface system 2 provides an optimized and simplified means for controlling the selected subsystem, with controls 4 that dynamically change appearance, including labeling and icons, depending upon which subsystem is active. Furthermore, the appearance of the controls 4 dynamically change based on the functions within the selected active subsystem.

While certain representative embodiments and details have been shown for purposes of illustrating the invention, it will be apparent to those skilled in the art that various changes may be made without departing from the scope of the disclosure, which is further described in the following appended claims.

What is claimed is:

1. An interface system, comprising:
a control having a substantially transparent main body;
a projector configured to project a plurality of control markings onto the main body of the control; and
a controller in communication with the projector and configured to cause the projector to project one of the plurality of control markings onto the main body of the control, the one of the plurality of control markings being dependent upon a selection of a subsystem to be managed by the interface system.

2. The interface system of claim 1, wherein the control is manually actuatable from a first position to a second position.

3. The interface system of claim 2, wherein the control is one of a knob and a button.

4. The interface system of claim 1, further comprising a switch in communication with the controller.

5. The interface system of claim 4, wherein the switch is employed to select the subsystem to be managed by the interface system.

6. The interface system of claim 1, further comprising a sensor in communication with the controller.

7. The interface system of claim 6, wherein the sensor is configured to detect an actuation of the control by a user.

8. The interface system of claim 1, further comprising a camera in communication with the controller.

9. The interface system of claim 8, wherein the camera is configured to detect an actuation of the control by a user.

10. The interface system of claim 1, further comprising at least one substantially transparent screen disposed adjacent the control.

11. The interface system of claim 10, wherein the projector is configured to project the plurality of control markings onto the at least one screen.

12. The interface system of claim 11, further comprising a camera in communication with the controller, wherein the camera is configured to detect an interaction of a user with the at least one screen, and the screen may be employed by the user for the selection of the subsystem to be managed by the interface system.

13. The interface system of claim 1, wherein the one of the plurality of control markings is at least one of an icon, a label, and a graphical representative of the selected subsystem.

14. The interface system of claim 13, wherein the one of the plurality of control markings may be dynamically altered in response to a change in the selected subsystem.

15. The interface system of claim 14, wherein the one of the plurality of control markings includes at least one arc disposed adjacent a side surface of the control.

16. The interface system of claim 15, wherein at least one of a length and a color of the at least one arc is altered in response to the change in the selected subsystem.

17. The interface system of claim 14, wherein at least one of a font, a color, and a size of the one of the plurality of control markings is altered in response to the change in the selected subsystem.

18. The interface system of claim 1, wherein the subsystem to be managed by the interface system includes at least one of a climate control system and a media system for a vehicle.

19. An interface system, comprising:
a control having a substantially transparent main body;
a projector configured to project a plurality of control markings onto the main body;
a controller in communication with the projector and configured to cause the projector to project one of the plurality of control markings onto the main body, the one of the plurality of control markings being dependent upon a selection of a subsystem to be managed by the interface system; and
a camera in communication with the controller, the camera configured to detect an actuation of the control by a user and communicate the actuation to the controller,
wherein the one of the plurality of control markings is dynamically altered in response to a change in the selected subsystem caused by the actuation of the control by the user.

20. An interface system, comprising:
a control having a substantially transparent main body;
at least one substantially transparent screen disposed adjacent the control;
a projector configured to project a plurality of control markings onto the main body of the control and the at least one screen;
a controller in communication with the projector and configured to cause the projector to project one of the plurality of control markings onto the main body of the control and another one of the plurality of control markings onto the screen, the one of the plurality of control markings and the another one of the plurality of control markings being dependent upon a selection of a subsystem to be managed by the interface system,
a camera in communication with the controller, the camera configured to detect an actuation of the control by a user and communicate the actuation to the controller; and
wherein at least one of the one of the plurality of control markings and the another one of the plurality of control markings is dynamically altered in response to a change in the selected subsystem caused by the actuation of the control by the user.
